(19) United States
(12) Patent Application Publication
(10) Pub. No.: US 2026/0122197 A1
(43) Pub. Date: Apr. 30, 2026

(54) IMAGE PROCESSING DEVICE AND CONTROL METHOD FOR IMAGE PROCESSING DEVICE

(71) Applicant: Sharp Kabushiki Kaisha, Osaka (JP)

(72) Inventor: AKIHITO YOSHIDA, Osaka (JP)

(21) Appl. No.: 19/181,702

(22) Filed: Apr. 17, 2025

(30) Foreign Application Priority Data
Apr. 26, 2024 (JP) 2024-072431

(51) Int. Cl. H04N 1/60; G06T 7/00; G06T 7/90

(52) U.S. Cl. CPC H04N 1/6077; G06T 7/001; G06T 7/90; G06T 2207/10024; G06T 2207/30144; G06T 2207/30168; G06T 2207/30176; H04N 2201/0094

(57) ABSTRACT

An image processing device includes a controller and an image acquiring device. The controller acquires, by using the image acquiring device, a document image including a first image, a second image, and a third image generated sequentially by using a first sensor, a second sensor, and a third sensor, respectively, the first sensor, second sensor, and third sensor being image sensors that are arranged in accordance with a predetermined order relationship along a conveying direction of a document and read color components of three colors different from each other, compares the first image, second image, and third image with each other, and determines whether the document image contains a color shift from the document, based on a result of the comparison.

### CROSS-REFERENCE TO RELATED APPLICATION

The present application claims priority from Japanese Application JP2024-072431, filed on Apr. 26, 2024, the entire contents of which are incorporated herein by reference.

### BACKGROUND

The present disclosure relates to a color shift of a scanned image generated by a scanner, and more particularly to a color shift of a scanned image occurring in a scanner including a document feeder (document conveyor).

In a scanner including a document feeder, when a document conveyed by the document feeder is scanned, a conveyance speed of the document may change due to a slip or the like of the document caused in a scanning process. Such a change in the conveyance speed may cause a color shift in the scanned image.

In relation to a color shift occurring in a scanned image, in one known technique for an image processing device, a black edge pixel in a color image is determined, and color shift correction is performed on a pixel located within a predetermined color shift correction width in a sub-scanning direction from the determined black edge pixel.

### SUMMARY

An object of the disclosure is to provide an image processing device that detects occurrence of a color shift in a document image.

An image processing device according to the disclosure includes a controller and an image acquiring device, wherein the controller acquires a document image including a first image, a second image, and a third image generated sequentially by using a first sensor, a second sensor, and a third sensor, respectively, the first sensor, second sensor, and third sensor being image sensors that are arranged in accordance with a predetermined order relationship along a conveying direction of a document and read color components of three colors different from each other, compares the first image, second image, and third image with each other, and determines whether the document image contains a color shift from the document based on a result of the comparison.

A control method for an image processing device executed by one or more processors according to the disclosure, includes acquiring, from an image acquiring device, a document image including a first image, a second image, and a third image generated sequentially by using a first sensor, a second sensor, and a third sensor, respectively, the first sensor, second sensor, and third sensor being image sensors that are arranged in accordance with a predetermined order relationship along a conveying direction of a document, and read color components of three colors different from each other, comparing the first, second, and third images with each other, and determining whether the document image contains a color shift from the document based on a result of the comparison.

According to the present disclosure, it is possible to provide an image processing device that detects occurrence of a color shift in a document image.

### BRIEF DESCRIPTION OF THE DRAWINGS

FIG. 1 is an external perspective view of a Multi-Function Printer/Peripheral (MFP) according to a first embodiment of the disclosure.

FIG. 2 is a functional block diagram of the MFP according to the first embodiment of the disclosure.

FIG. 3A is a diagram for explaining a change in a positional relationship between a document and a sensor RGB in a case where there is no change in a conveyance speed and no color shift occurs, and illustrates the positional relationship between the document and the sensor RGB immediately before starting capturing a black region.

FIG. 3B is a diagram illustrating the positional relationship between the document and the sensor RGB at a timing when a blue sensor captures the black region.

FIG. 3C is a diagram illustrating the positional relationship between the document and the sensor RGB at a timing when a green sensor captures the black region.

FIG. 3D is a diagram illustrating the positional relationship between the document and the sensor RGB at a timing when a red sensor captures the black region.

FIG. 4A is a diagram for explaining the change in the positional relationship between the document and the sensor RGB in a case where the conveyance speed changes and the color shift occurs, and illustrates the positional relationship between the document and the sensor RGB immediately before starting capturing the black region.

FIG. 4B is a diagram illustrating the positional relationship between the document and the sensor RGB at a timing when the blue sensor captures the black region.

FIG. 4C is a diagram illustrating the positional relationship between the document and the sensor RGB at a timing when the green sensor captures the black region.

FIG. 4D is a diagram illustrating the positional relationship between the document and the sensor RGB at a timing when the red sensor captures the black region.

FIG. 5 is a flowchart for explaining an operation of the MFP according to the first embodiment of the disclosure.

FIG. 6A is a diagram for explaining a method of detecting a color shift portion and illustrates a document image of a document (name card).

FIG. 6B is a partial enlarged view in which a region where a color shift occurs in the document image in FIG. 6A is enlarged.

FIG. 7 is a diagram for explaining a method of detecting a color shift portion to explain detection of a color shift by comparing a red channel component and a blue channel component of the document image in FIG. 6B.

FIG. 8 is a diagram for explaining a method of specifying, from a document image, a range in which the conveyance speed varies.

FIG. 9 is a partially enlarged view of the document image in FIG. 8 for explaining the method of specifying, from the document image, the range in which the conveyance speed varies.

FIG. 10 is a flowchart for explaining an operation of an MFP according to a second embodiment of the disclosure.

FIG. 11 is a flowchart for explaining an operation of color shift detection of the MFP according to the second embodiment of the disclosure.

FIG. 12A is a table for explaining a color shift occurrence situation in a three-line CCD, where no color shift occurs, and shows a correspondence between a position on a document (on-document position, Y-coordinate value) and a pixel value.

FIG. 12B is a table showing lengths of inter-color sensor gaps between a sensor LR and a sensor LG, and between the sensor LG and a sensor LB.

FIG. 12C is a table showing a correspondence relationship between a document feeding condition and an on-document position read by each sensor.

FIG. 12D is a table showing a correspondence relationship between the on-document positions read by the sensors LB, LG, and LR, where the respective on-document positions are shifted by the respective inter-color sensor gaps and combined.

FIG. 12E is a table showing pixel values output by the sensors LB, LG, and LR at the on-document positions in FIG. 12D and a color determined by a combination of the pixel values.

FIG. 13A is a table for explaining a color shift occurrence situation in a scanned image generated using the three-line CCD, where a color shift occurs, and shows a correspondence between a position on a document (on-document position, Y-coordinate value) and a pixel value.

FIG. 13B is a table showing sizes of gaps between the sensor LR and the sensor LG, and between the sensor LG and the sensor LB.

FIG. 13C is a table showing a correspondence relationship between the number of pixels (document feeding condition) corresponding to a distance by which the document is conveyed until the next reading timing of the sensors LB, LG, and LR, and the on-document positions currently being read by the sensors LB, LG, and LR.

FIG. 13D is a table showing the on-document positions read by the sensors LB, LG, and LR at each reading timing.

FIG. 13E is a table showing pixel values at the on-document positions read by the sensors LB, LG, and LR at each reading timing, and a color determined by a combination of the pixel values.

FIG. 14A is a table for explaining another color shift occurrence situation in a scanned image generated using the three-line CCD, where a color shift occurs, and shows a correspondence between a position on a document (on-document position, Y-coordinate value) and a pixel value.

FIG. 14B is a table showing sizes of gaps between the sensor LR and the sensor LG, and between the sensor LG and the sensor LB.

FIG. 14C is a table showing a correspondence relationship between the number of pixels (document feeding condition) corresponding to a distance by which the document is conveyed until the next reading timing of the sensors LB, LG, and LR, and the on-document positions currently being read by the sensors LB, LG, and LR.

FIG. 14D is a table showing the on-document positions read by the sensors LB, LG, and LR at each reading timing.

FIG. 14E is a table showing pixel values at the on-document positions read by the sensors LB, LG, and LR at each reading timing, and a color determined by a combination of the pixel values.

FIG. 15 is a diagram illustrating a document feeding shift of one pixel and a document feeding shift of two pixels that occur in a scanned image generated using the three-line CCD.

FIG. 16A is a schematic diagram for explaining a document feeding shift of one pixel.

FIG. 16B is a schematic diagram for explaining a document feeding shift of two pixels.

FIG. 17A is a diagram for explaining a method of estimating a portion where the three-line CCD repeatedly reads the same position on a document, based on a color shift occurring in a scanned image generated using the three-line CCD, to specify a portion including the color shift in the scanned image.

FIG. 17B is a graph showing a correspondence between the pixel values of RGB and the Y-coordinate value in the portion specified in FIG. 17A.

FIG. 18A is a table for showing a method of estimating a portion where the three-line CCD repeatedly reads the same position on a document, based on a color shift occurring in a scanned image generated using the three-line CCD, representing a correspondence relationship between rising/falling, a color of the color shift, and a delayed location of an R pixel.

FIG. 18B illustrates tables, excerpted from FIG. 13D and FIG. 13E, for explaining a case where a color of the color shift is cyan.

FIG. 18C is a diagram for explaining a relationship between the delayed locations of an R pixel, a G pixel, and a B pixel.

FIG. 19 is a diagram for explaining a map function for color shift correction.

FIG. 20 is a functional block diagram of an image processing device according to a third embodiment of the disclosure.

FIG. 21 is a flowchart for explaining an operation of an MFP according to a fourth embodiment of the disclosure.

FIG. 22 is a diagram for explaining a medium used when creating a color document in a variation of a fifth embodiment of the disclosure.

### DETAILED DESCRIPTION

Hereinafter, an embodiment in which an image processing device according to the disclosure is applied to an MFP (Multi-Function Printer/Peripheral) is described. Note that the following embodiments describe examples of the inventions described in the claims, and the technical scope of the present invention is not limited to the following embodiments. In addition, in the following embodiments, a case where the image processing device according to the disclosure is applied to the MFP is described, but the image processing device is not limited to the MFP. For example, the present invention can be applied to an apparatus processing an image such as a scanner apparatus or a camera apparatus as the image processing device.

### 1. First Embodiment

For example, in the Multi-Function Printer/Peripheral (MFP), when a document is scanned to generate a document image, a document conveyor conveys the document and an image inputter reads the document to generate a document image in the MFP. At this time, the image inputter reads a document that originally performs uniform linear motion. However, for example, the conveyance speed of the document may be delayed due to the influence of glue or the like adhering to a conveyance path of the document conveyor. In such a case, a color shift may occur in the document image as described in detail later. In the first embodiment, this color shift is detected.

### 1.1 Hardware Configuration

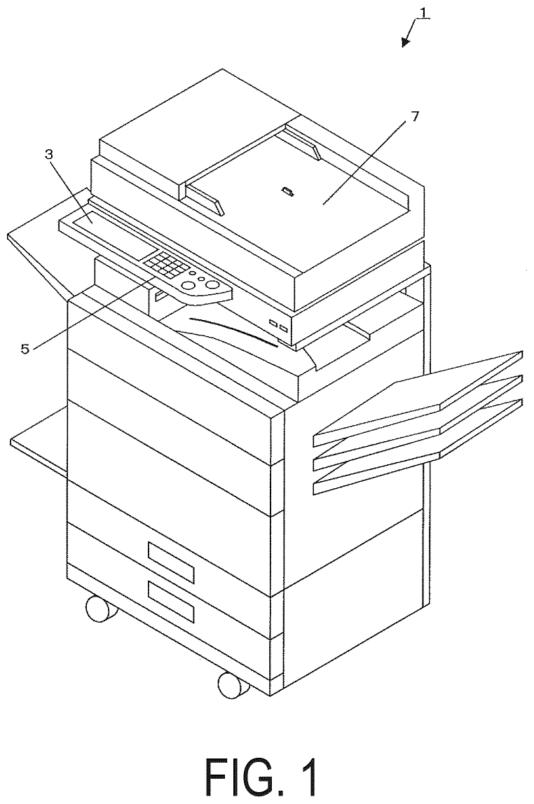

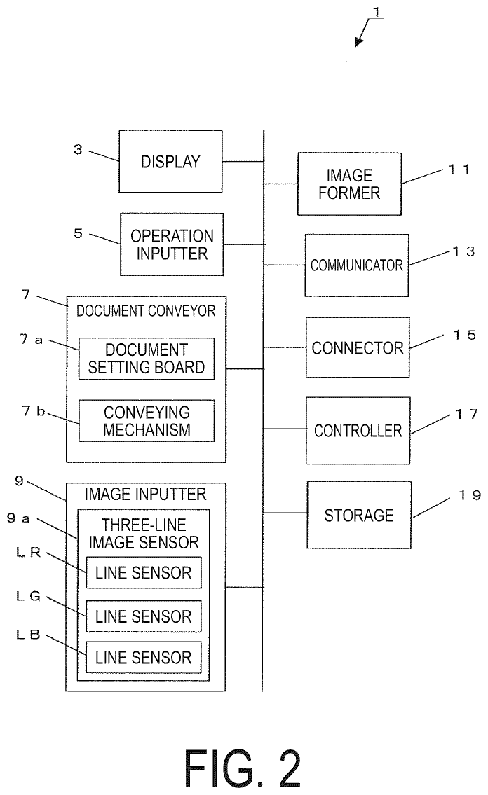

FIG. 1 is an external perspective view of a Multi-Function Printer/Peripheral (MFP) 1 according to a first embodiment of the disclosure. FIG. 2 is a functional block diagram of the MFP according to the first embodiment of the disclosure. The MFP 1 is also called a multi-function printer, and typically has copy, image scanner, facsimile, and printer functions. The MFP 1 includes a display 3, an operation inputter 5, a document conveyor 7, an image inputter 9, an image former 11, a communicator 13, a connector 15, a controller 17, and a storage 19. The MFP 1 includes an image acquiring device as an image acquirer that acquires an image. The image inputter 9 mainly functions as the image acquiring device. The image acquiring device may be, as a part of acquiring an image, for example, the connector 15 capable of acquiring an image by being connected to another device, or the communicator 13 capable of acquiring an image by communicating with another device.

The display 3 displays images and characters. The display 3 is composed of, for example, a liquid crystal display (LCD) or an organic electro-luminescence (EL) panel. The display 3 may be a single display device, or may further include a display device connected to the outside.

The operation inputter 5 receives an operation input from a user. For example, the operation inputter 5 is composed of hardware keys or software keys. Further, the operation inputter 5 includes task keys for instructing to execute tasks such as fax transmission and image reading, and operation keys such as a cancel key for instructing to cancel an operation, for example.

The document conveyor 7 includes a document setting board 7a and a conveying mechanism 7b. The document setting board 7a is a board for setting a sheet of paper, that is, one or more documents, on which an image to be read by the image inputter 9 is drawn. The conveying mechanism 7b conveys the document set on the document setting board 7a to the image inputter 9, and discharges the document whose image has been input by the image inputter 9. The document conveyor 7 includes a conveying path for conveying a document and a conveying roller that rotates while being in contact with the document to move the document on the conveying path.

The image inputter 9 reads and outputs, as image data (scanned image), an image formed on a surface of the sheet of the document. The image inputter 9 is composed of an image scanner (image input device). The image inputter 9 has a reading surface on which a document is placed. The reading surface is made of a transparent plate-like member such as a glass plate.

The image inputter 9 includes a three-line image sensor 9a below the reading surface. The three-line image sensor 9a includes three line image sensors LR, LG, and LB, which are a line image sensor for reading red color, a line image sensor for reading green color, and a line image sensor for reading blue color, respectively. Hereinafter, the line image sensors that read red, green, and blue are also referred to as sensors LR, LG, and LB, respectively. These sensors are also collectively referred to as sensor RGB. The sensor RGB includes a solid-state imaging element such as a charge coupled device (CCD) or a complementary metal-oxide-semiconductor (CMOS).

The sensor RGB is arranged along a direction (document feeding direction) in which the document conveyor 7 conveys the document. That is, the sensor LB, the sensor LG, and the sensor LR are arranged in this order along the document feeding direction from the rear to the front in the document feeding direction. Therefore, when the document conveyor 7 conveys the document, a leading edge of the document reaches a position of each of the sensor LB, the sensor LG, and the sensor LR in this order. In other words, a certain point P on the document conveyed to the image inputter 9 first moves to a position directly facing the sensor LB and is read by the sensor LB. After the document is further conveyed, the point P moves to a position directly facing the sensor LG and is read by the sensor LG. After the document is further conveyed, the point P moves to a position directly facing the sensor LR and is read by the sensor LR. A gap having a predetermined length is provided between the sensor LB and the sensor LG. Similarly, a gap having the same length is provided between the sensor LG and the sensor LR.

The image former 11 forms (prints) an image on a medium such as copy paper based on the image data. Any printing method of the image former is used, and for example, any of an inkjet printer, a laser printer, and a thermal transfer printer may be used. The image former may be a monochrome printer or a color printer.

The communicator 13 connects to a network. For example, the communicator 13 is composed of an interface connectible to a wired local area network (LAN), a wireless LAN, or a long term evolution (LTE) network. When being connected to a network, the communicator 13 is connected to other devices or an external network. Note that the communicator 13 may be an interface that performs short-range wireless communication such as near field communication (NFC) or Bluetooth (trade name), for example.

The connector 15 connects the MFP 1 to another device. For example, the connector 15 is a USB interface, and a USB memory is connected thereto. Other than a USB interface, the connector 15 may be a HDMI (trade name) interface or the like.

The controller 17 controls the entire MFP 1. The controller 17 is composed of, for example, one or more control devices/arithmetic devices or a control circuit, for example, composed of a central processing unit (CPU) that is a processor executing various arithmetic processing, or a system-on-chip (SoC). The controller 17 can realize each function by reading programs stored in the storage 19 and executing processing. In particular, the controller 17 performs image processing on an image acquired from the image acquirer, specifically, an image input from the image inputter 9, an image acquired from another device connected via the connector 15, and an image acquired from another device connected via the communicator 13 and a communication line. Further, the controller 17 may serve as the image processor, and some or all of the processors included in the controller 17 may be composed of electronic circuits.

The storage 19 stores various programs and various types of data necessary for the operation of the MFP 1. The storage 19 includes one or more of a recording device capable of transitory storage, such as a dynamic random access memory (DRAM), or a non-transitory recording device such as a solid state drive (SSD) constituted by a semiconductor memory or a hard disk drive (HDD) constituted by a magnetic disk. Further, although illustrated as a single component for convenience of description, the storage 19 may be configured as separate devices for each application, such as a region (main storage region) utilized for execution of a program, a region (auxiliary storage region) for storing programs or data, and a region utilized for a cache.

### 1.2 Occurrence of Color Shift

Prior to describing the operation of the MFP 1, a mechanism by which a color shift occurs is described. When the document conveyor 7 operates normally, the document is conveyed at a constant speed. The sensors LB, LG, and LR of the image inputter 9 image a region of the document facing the sensors at respective time at a predetermined timing determined on the assumption that the document is conveyed at a constant speed, and output signals B, G, and R, respectively. By combining the signals B, G, and R obtained in this way based on the imaging timing and an arrangement relationship of the sensors LB, LG, and LR, a pixel on the document image corresponding to an arbitrary position on the document is obtained as a combination of the signal B, the signal G, and the signal R.

However, there is a case where an abnormality occurs in the document conveyor 7, conveyance of the document is stopped for a very short time, and the conveyance of the document is delayed. Such an abnormality occurs, for example, when the document conveyor 7 conveys the document, the document receives a temporary resistance, and thus a conveyance roller instantaneously slips.

Due to such a delay in conveyance of the document, timings at which the sensors LB, LG, and LR acquire pixel values from the document are shifted. At this time, the combination of the signals B, G, and R is shifted from the original combination. As a result, a color different from that of the document appears on the document image, thereby causing a color shift.

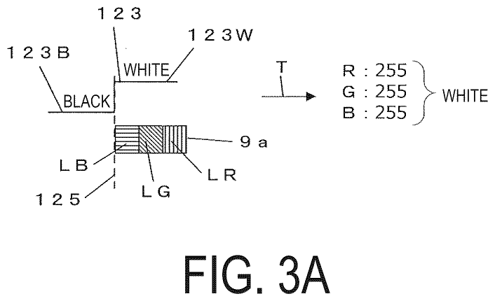

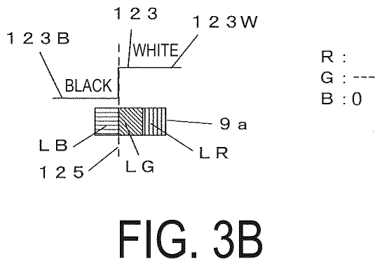

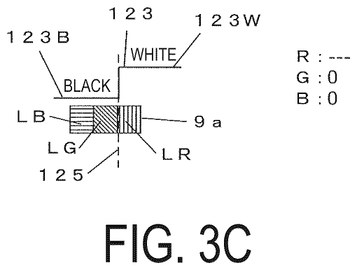

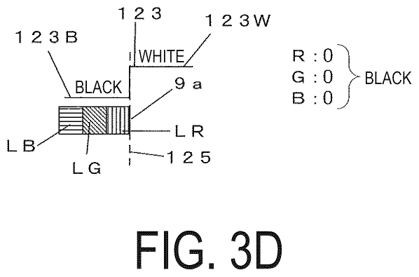

Hereinafter, the mechanism of occurrence of color shift is described in more detail. FIGS. 3A, 3B, 3C, and 3D are diagrams for explaining a change in a positional relationship between a document 123 and the sensor RGB in a case where there is no change in the conveyance speed and no color shift occurs. As described above, the sensors LB, LG, and LR are arranged along the conveying direction T of the document 123 in the order of the sensors LB, LG, and LR from the rear to the front in the conveying direction T. For the purpose of simple description, it is assumed that the sensors LB, LG, and LR are arranged adjacent to each other without any gap. The document 123 is monochrome with two gradations or multiple gradations, and includes a white region 123W and a black region 123B.

When the document 123 is conveyed in the conveying direction T, the sensors LB, LG, and LR read the document 123 line by line and output signals B, G, and R, respectively. Each of the signals B, G, and R ranges from 0 to 255, and the combination of the outputs of the signals B, G, and R determines a color of the read line. For example, in a case where values of the signals B, G, and R are all 255, the color of the line is white, and in a case where the values of the signals B, G, and R are all 0, the color of the line is black. The document 123 includes the black region 123B and the white region 123W. A black-white boundary 125 indicates a position of a boundary between the black region 123B and the white region 123W. The white region 123W is first detected and then the black region 123B is detected by the sensors LB, LG, and LR.

FIG. 3A illustrates the positional relationship between the document 123 and the sensor RGB immediately before starting capturing the black region 123B. At this time, the black-white boundary 125 has not yet reached the position of the sensor LB. Therefore, none of the sensors LB, LG, and LR read the black region 123B.

FIG. 3B illustrates the positional relationship between the document 123 and the sensor RGB at a timing when the blue sensor LB captures the black region 123B. In FIG. 3B, compared to FIG. 3A, the document 123 forward moves in the conveying direction T, and the black-white boundary 125 reaches a boundary between the sensor LB and the sensor LG. At this timing, the sensor LB reads the black region 123B and outputs a signal B having a value of 0.

FIG. 3C illustrates the positional relationship between the document 123 and the sensor RGB at a timing when the green sensor LG captures the black region 123B. In FIG. 3C, the document 123 forward moves in the conveying direction T farther than in FIB. 3B, and the black-white boundary 125 reaches a boundary between the sensor LG and the sensor LR. At this timing, the sensor LG reads the black region 123B and outputs a signal G having a value of 0.

FIG. 3D illustrates the positional relationship between the document 123 and the sensor RGB at a timing when the red sensor LR captures the black region 123B. In FIG. 3D, the document 123 forward moves in the conveying direction T farther than in FIB. 3C, and the black-white boundary 125 reaches an end of the sensor LR (an end on the front side in the conveying direction T). At this time, the sensor LR reads the black region 123B and outputs a signal R having a value of 0.

In FIGS. 3B, 3C, and 3D, a result of reading the black region 123B is obtained by combining the signals B, G, and R output from the sensors LB, LG, and LR, respectively. Since signal B=signal G=signal R=0 is output in FIGS. 3B, 3C and 3D, the color read by the image inputter 9 is black.

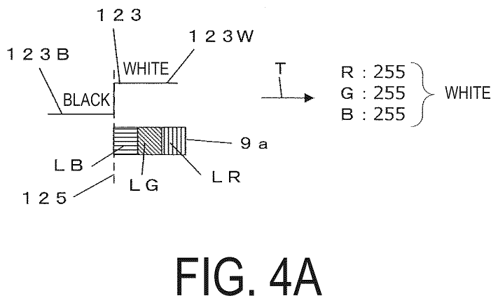

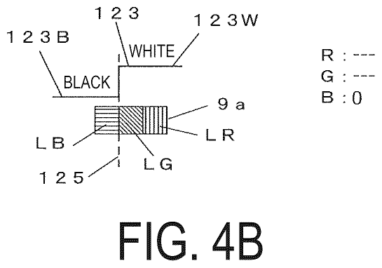

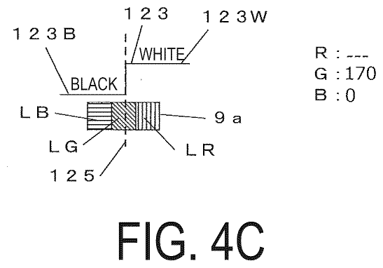

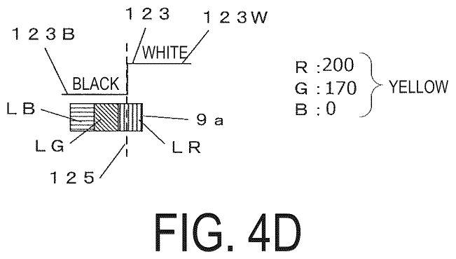

Next, with reference to FIGS. 4A, 4B, 4C, and 4D, a description is given of a change in the positional relationship between the document and the sensor RGB in a case where the conveyance speed changes and a color shift occurs. The document 123 read in FIGS. 4A to 4D is the same as the document 123 read in FIGS. 3A to 3D, and includes the black region 123B and the white region 123W. FIGS. 4A to 4D are different, from FIGS. 3A to 3D in comparison, in that a delay occurs in the conveyance of the document 123 in the process in which the sensor RGB reads the document 123.

FIG. 4A illustrates the positional relationship between the document and the sensor RGB immediately before starting capturing the black region. FIG. 4B illustrates the positional relationship between the document and the sensor RGB at a timing when the blue sensor LB captures the black region. FIG. 4A and FIG. 4B are the same as FIG. 3A and FIG. 3B, respectively, and therefore description thereof is omitted.

FIG. 4C illustrates the positional relationship between the document 123 and the sensor RGB at a timing when the green sensor LG captures the black region 123B. The black-white boundary 125 in FIG. 3C reaches the boundary between the sensor LG and the sensor LR, whereas the black-white boundary 125 in FIG. 4C does not reach the boundary between the sensor LG and the sensor LR because the conveyance of the document is delayed. Therefore, at this timing, the region including the black-white boundary 125, that is, both the white region 123W and the black region 123B are located at positions directly facing the sensor LG. As a result, the sensor LG outputs a value corresponding to an area ratio between the white region 123W and the black region 123B facing the sensor LG at this timing. In FIG. 4C, the sensor LG outputs a signal G having a value of 170.

FIG. 4D illustrates the positional relationship between the document and the sensor RGB at a timing when the red sensor LR captures the black region. The black-white boundary 125 in FIG. 3D reaches the end of the sensor LR on the front side in the conveying direction, whereas the black-white boundary 125 in FIG. 4D does not reach the end of the sensor LR on the front side in the conveying direction due to the delay in conveyance of the document. Therefore, at this timing, the region including the black-white boundary 125, that is, both the white region 123W and the black region 123B are located at positions directly facing the sensor LR. As a result, the sensor LR outputs a value corresponding to an area ratio between the white region 123W and the black region 123B facing the sensor LR at this timing. In FIG. 4D, the sensor LR outputs a signal R having a value of 200.

In FIGS. 4B, 4C, and 4D, a yellow region is obtained as a result of reading the black region 123B by combining the signal B=0, the signal G=170, and the signal R=200 output from the sensors LB, LG, and LR, respectively. In this way, the black region 123B on the document 123 appears as the yellow region in the document image due to the color shift caused by the delay in conveyance.

### 1.3 Operation of MFP 1

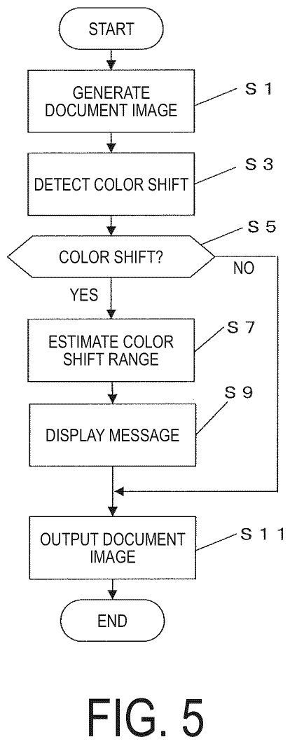

FIG. 5 is a flowchart for explaining an operation of the MFP 1 according to the first embodiment of the disclosure. The controller 17 controls the document conveyor 7 to convey a document and controls the image inputter 9 to read the document to generate a document image (step S1). Next, the controller 17 detects a color shift in the document image (step S3). A method of detecting the color shift is described later. In a case where there is a color shift (Yes in step S5), the controller 17 specifies a range of the color shift (step S7). A method of specifying the range of the color shift is described later. Next, the controller 17 displays a message on the display 3 (step S9), and outputs the document image (step S11). In a case where there is no color shift (No in step S3), the controller 17 outputs the document image without displaying the message (step S11).

An output destination of the document image may be the display 3, the storage 19, another device connected via the connector 15, or another device connected via the communicator 13 and a communication line.

The message displayed on the display 3 is a message concerning the color shift, and specifically includes whether there is a color shift, a position of a pixel where the color shift occurs in the document image, a color appearing in the document image due to the color shift, an original color of the pixel where the color shift occurs, and the like. Concerning the color appearing in the document image due to the color shift and the original color of the pixel where the color shift occurs, for example, a rectangular region filled with those colors may be displayed as a part of the message.

### 1.3.1 Detection of Color Shift

The method of detecting the color shift in step S3 is described. As described above, when the conveyance speed changes, the outputs of the sensors LB, LG, and LR are affected, and a document image containing a color shift from the document is generated. A portion where a color shift has occurred is detected from such a document image as described below.

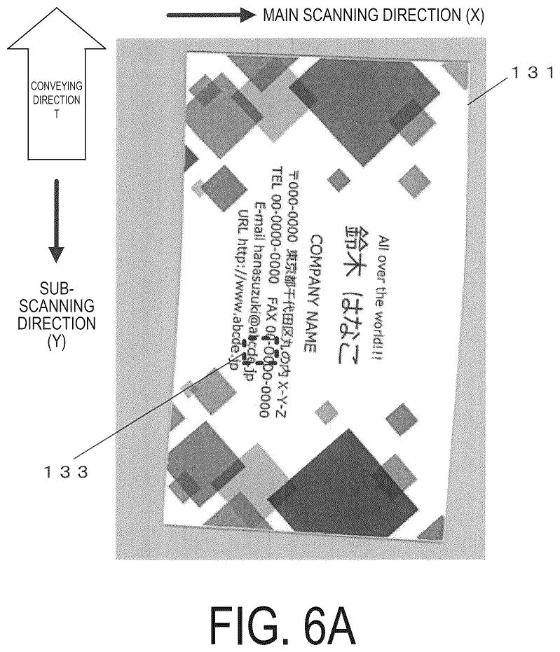

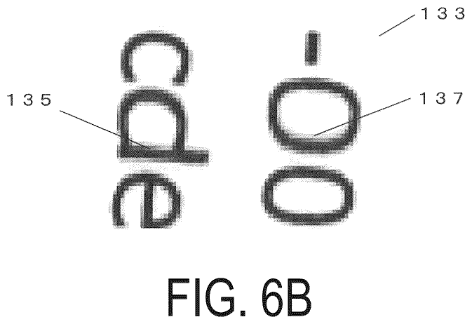

FIG. 6A and FIG. 6B are diagrams for explaining the method of detecting a color shift portion. FIG. 6A illustrates a document image 131 of a document (name card). FIG. 6B is a partial enlarged view in which a region 133 where a color shift occurs in the document image 131 in FIG. 6A is enlarged. FIG. 6A illustrates a state in which a document image 131 representing a name card is read into a region 130 representing a background. Although the document image is an image and contains a character image (for example, Japanese characters and English characters), the document is described as an image in the present embodiment. Therefore, the characters drawn in the document image 131 are described as an example of an image, and the meaning of the characters themselves need not be considered. The region 133 contains color shift portions 135 and 137. The color shift portions 135 and 137 were originally black regions in the document, but the colors of both are changed to cyan due to the color shift in the document image 131.

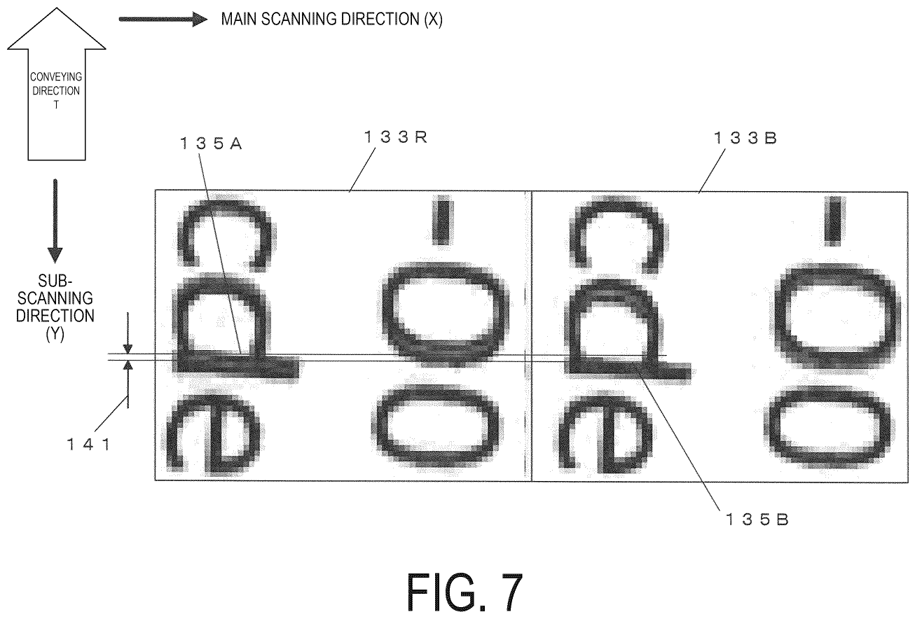

Here, terms relating to directions are described for the following. The conveying direction T is a direction in which the document is conveyed through the image inputter 9 by the document conveyor 7. A direction in which the document is conveyed forward is the front in the conveying direction, and the opposite direction is the rear in the conveying direction. A sub-scanning direction is a direction in which the image inputter 9 reads a document. The front and rear in the sub-scanning direction are opposite to the front and rear in the conveying direction. A main scanning direction is a direction orthogonal to the sub-scanning direction and the conveying direction. When facing the front in the sub-scanning direction, a right direction is the front in the main scanning direction, and a left direction is the rear in the main scanning direction. In FIG. 6A, arrows indicate the fronts in the conveying direction, the sub-scanning direction (Y), and the main scanning direction (X). Note that, in FIGS. 7 to 9, 15, and 18, the similar arrows are indicated.

FIG. 7 is a diagram for explaining the method of detecting a color shift portion. An image denoted by 133R is a portion of red channel components of the document image 131 and corresponds to the region 133 in FIG. 6B. An image denoted by 133B is a portion of blue channel components of the document image 131 and corresponds to the region 133 in FIG. 6B. The portion where the color shift occurs can be detected by obtaining a difference between the image denoted by 133R and the image denoted by 133B. Note that the red channel component is an image consisting of the signal R among the signals R, G, and B constituting the document image 131. Similarly, the green channel component is an image consisting of the signal G among the signals R, G, and B constituting the document image 131, and the blue channel component is an image consisting of the signal B among the signals R, G, and B constituting the document image 131.

In FIG. 7, there is a deviation between values of the red channel component 133R and the blue channel component 133B in a region between two straight lines 135A and 135B. Therefore, the color shift having a color shift width 141 can be detected by obtaining a difference between the red channel component 133R and the blue channel component 133B. In this way, a portion where the difference between two of the three color channel components of the document image is not 0 is detected as a color shift. Although the difference between the red channel component 133R and the blue channel component 133B is described as an example, the color shift may be detected based on the difference between the corresponding green channel component (not illustrated) and the red channel component 133R or the difference between the corresponding green channel component (not illustrated) and the blue channel component 133B.

### 1.3.2 Estimation of Color Shift Range

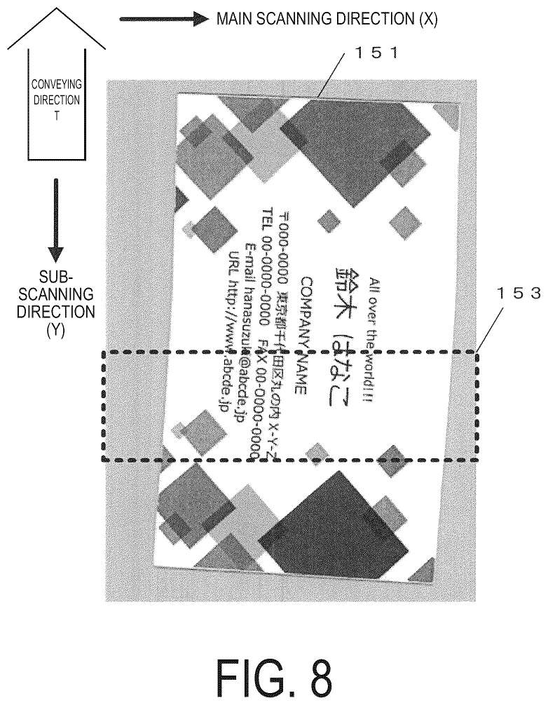

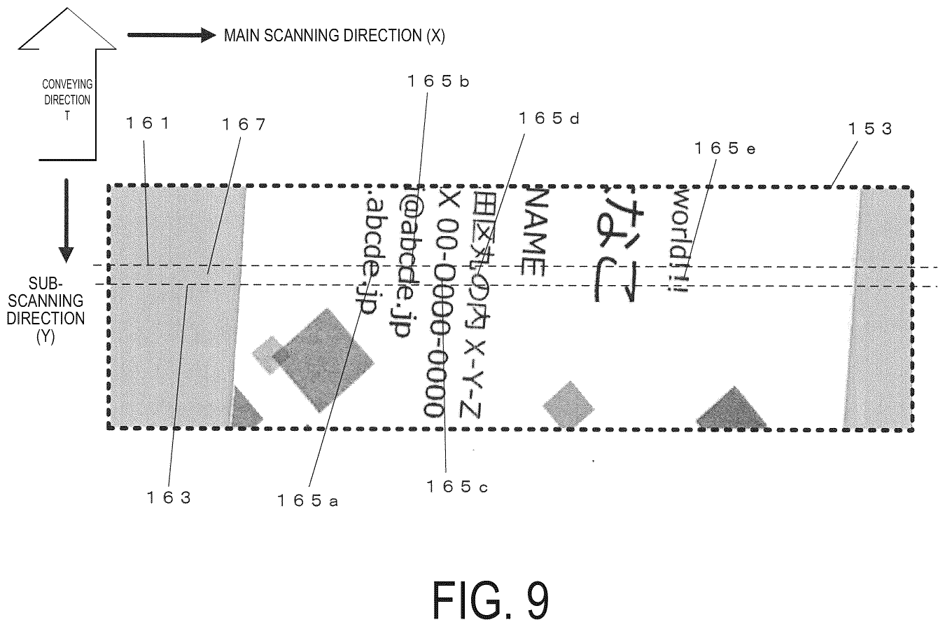

The method of specifying the range of the color shift in step S7 is described. FIG. 8 is a diagram for explaining the method of specifying, from a document image 151, a range in which the conveyance speed varies. FIG. 8 illustrates a state in which the document image 151 representing a name card is read into a region 150 representing a background. Although the document image is an image and contains a character image (for example, Japanese characters and English characters), the document is described as an image in the present embodiment. Therefore, the characters drawn in the document image 151 are described as an example of an image, and the meaning of the characters themselves need not be considered. FIG. 9 is a partially enlarged view of the document image 151 in FIG. 8 (region 153) for explaining the method of specifying, from the document image 151, the range in which the conveyance speed varies.

It is assumed that color shift portions 165a, 165b, 165c, 165d, and 165e are detected from the document image 151 as illustrated in FIG. 9 by the method of detecting the color shift in step S3 described above. At this time, the controller 17 obtains a straight line (dotted line 161) that passes the most forward color shift portion in the front in the conveying direction in the document image 151 and is orthogonal to the conveying direction. In addition, the controller 17 obtains a straight line (dotted line 163) that passes the most rearward color shift portion in the document image 151 and is orthogonal to the conveying direction. The controller 17 determines a region 167 between the dotted line 161 and the dotted line 163 as a range in which color shift occurs.

### 1.4 Effects

As described above, according to the first embodiment, occurrence of a color shift in a document image can be detected. Further, according to the first embodiment, a range in which a color shift occurs in the document image can be estimated.

### 2. Second Embodiment

A second embodiment of the disclosure is described. In the first embodiment, the color shift is detected based on the difference between the color channel components of the document image, but in the second embodiment, the change of the pixel value in the conveying direction of the document is compared between the color channels, and the color shift is detected based on the comparison result. In the first embodiment, the detected color shift is not corrected, but in the second embodiment, the detected color shift is corrected. Further, in the second embodiment, the color shift is corrected based on the detected color shift. Differences between the second embodiment and the first embodiment are mainly described below. The MFP 1 is also used in the second embodiment. Since the configuration of the MFP 1 is the same as that of the first embodiment, description thereof is omitted.

### 2.1 Operation of MFP 1

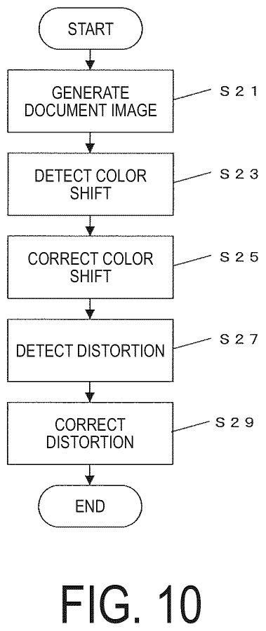

FIG. 10 is a flowchart for explaining an operation of an MFP according to the second embodiment of the disclosure. The controller 17 controls the document conveyor 7 to convey a document to the image inputter 9, and controls the image inputter 9 to generate a document image from the document (step S21). Next, the controller 17 detects a color shift in accordance with a method described later (step S23). Next, the controller 17 generates a document image in which the detected color shift is corrected to a color in the case where no color shift occurs (step S25). Next, the controller 17 detects a distortion of the document image based on the document image after the color shift is corrected (step S27). Next, the controller 17 generates a document image in which the detected distortion is corrected (step S29).

### 2.1.1 Color Shift Detection (Step S23)

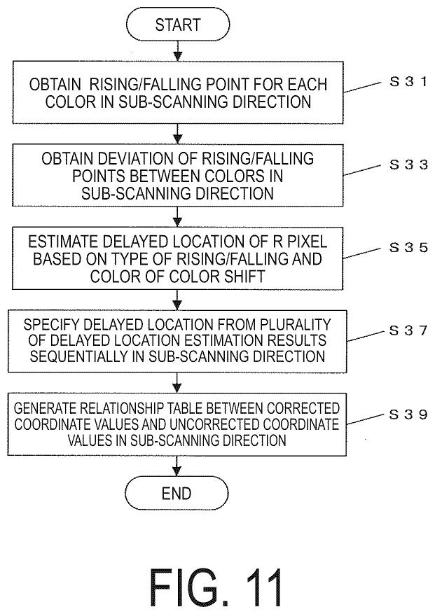

The color shift detection in step S23 is described. FIG. 11 is a flowchart for explaining an operation of the color shift detection of the MFP 1 according to the second embodiment of the disclosure.

The controller 17 obtains a rising point and a falling point in the sub-scanning direction in each of the color channel components (red channel component, green channel component, and blue channel component) of the document image (step S31). Each color channel component may include a plurality of rising points and may include a plurality of falling points.

Next, the controller 17 obtains a positional deviation of the rising points/falling points in the sub-scanning direction corresponding to each other between the color channel components (step S33). More specifically, a set of rising points corresponding to each other between the red channel component, the green channel component, and the blue channel component is obtained. The set of rising points includes three rising points of a rising point of a red channel component, a rising point of a green channel component, and a rising point of a blue channel component. The positional deviation in the sub-scanning direction between these three rising points is obtained. In a case where the color channel component includes a plurality of rising points, a plurality of sets of rising points are obtained, and in each set, the positional deviation in the sub-scanning direction between the rising points in the set is obtained. With respect to the falling point, similarly, the positional deviation in the sub-scanning direction between the falling points in each set of falling points is obtained.

Next, the controller 17 determines the type of rising/falling and the color of the color shift for the set of rising/falling points between which the positional deviation is obtained. Then, based on the determined type of rising/falling and the color of the color shift, a delayed location of the pixel of the red channel component is estimated (step S35).

Next, the controller 17 estimates a delayed location of the pixel of the green channel component and a delayed location of the pixel of the blue channel component based on the delayed location of the pixel of the red channel component estimated in step S35 and the inter-color sensor gap (step S37).

Next, the controller 17 generates a relationship table representing a relationship between corrected coordinate values and uncorrected coordinate values in the sub-scanning direction (step S39).

### 2.1.2 Color Shift Correction (Step S25)

The relationship table generated by means of the above-described color shift detection corresponds to a map function related to a color shift. Therefore, a document image in which a color shift is corrected is generated using the relationship table.

### 2.1.3 Distortion Detection and Distortion Correction (Steps S27 and S29)

A distortion is detected (step S25) based on the document image which is generated in step S27 and in which a color shift is corrected, and the detected distortion is corrected (step S29).

### 2.2 Color Shift Occurrence Situation in Three-Line CCD

### 2.2.1 Output of Three-Line CCD When No Color Shift Occurs

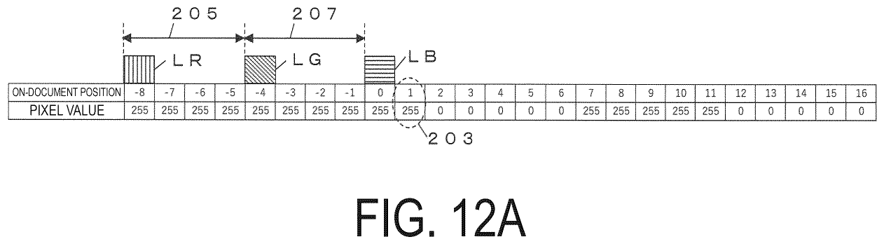

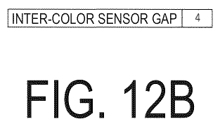

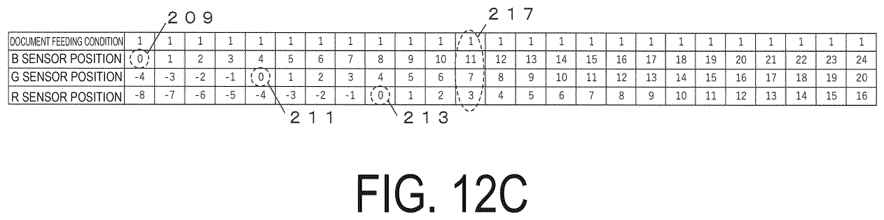

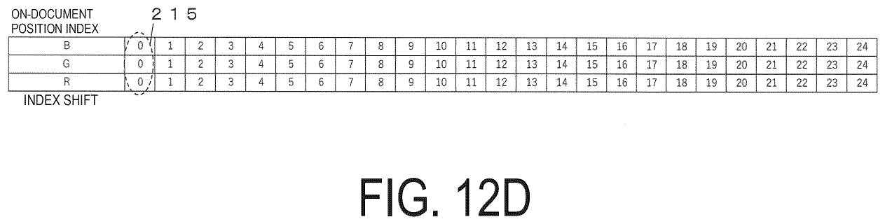

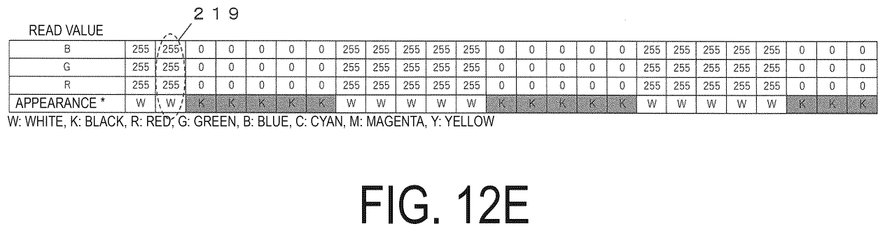

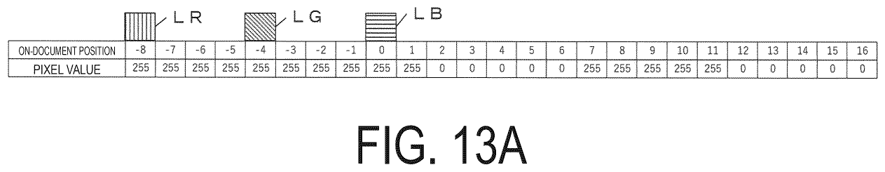

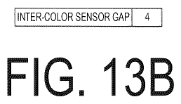

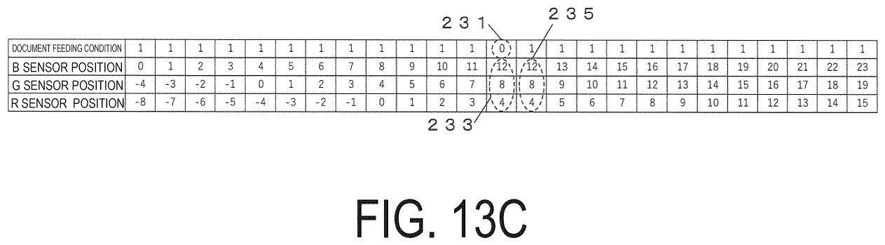

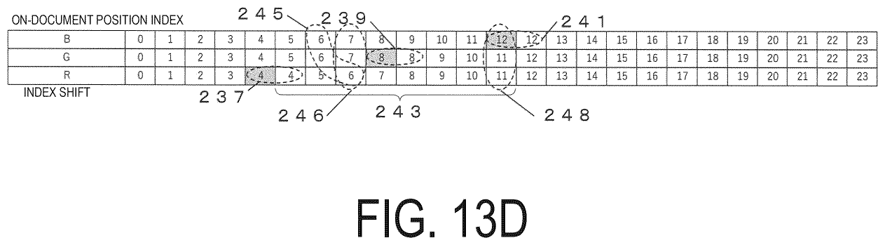

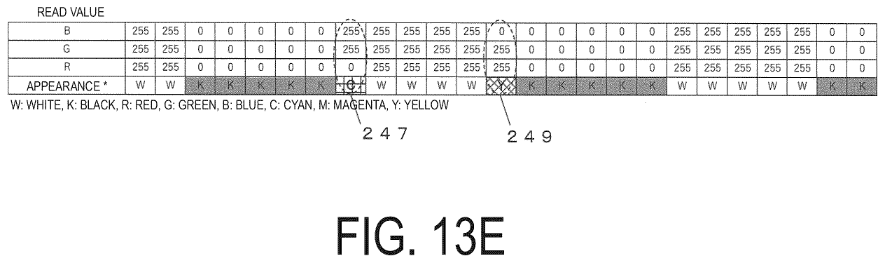

FIGS. 12A, 12B, 12C, 12D, and 12E are tables for explaining a color shift occurrence situation in the three-line CCD (sensors LR, LG, and LB). For comparison with FIGS. 13A to 13E to be described later, a situation where no color shift occurs is described in FIGS. 12A to 12E.

The sensors LR, LG, and LB are arranged in the order of the sensors LB, LG, and LR from the front in the conveying direction along which the document conveyor 7 conveys the document. When the document is conveyed, the sensors LB, LG, and LR read one line of the document in this arrangement order. Therefore, the sensors LB, LG, and LR do not read one line at the same time. The sensors LB, LG, and LR read one line of the document in this arrangement order.

There is an interval corresponding to the number of lines indicated in an inter-color sensor gap 205 between the sensors LR and LG. There is also an interval corresponding to the number of lines indicated in an inter-color sensor gap 207 between the sensors LG and LB. For the purpose of simple description, it is assumed that only two colors of white and black are used in the document. The lines are virtual rectangular regions obtained by dividing the document in the main scanning direction (direction orthogonal to the conveying direction). A line number is a number that starts from 0 and is assigned to each line according to the order in which the image inputter 9 reads the lines. Each of the sensors LB, LG, and LR starts reading from the on-document position #0 (line #0). Thus, the image inputter 9 generates a document image based on results of reading the on-document position #0 (line #0) and subsequent positions (lines) by the sensors LB, LG, and LR.

FIGS. 12A to 12E show a correspondence between a position on a document (on-document position, Y-coordinate value) and a pixel value. In the figures, the sensors LR, LG, and LB indicate their initial read on-document positions. An on-document position indicates a line on the document, and the pixel value indicates a pixel value of the line. When a pixel value of a line is 0, the line is black, and when a pixel value of a line is 255, the line is white. When the document conveyor 7 conveys the document by one line, the on-document positions read by the sensors LR, LG, and LB are shifted one by one to the right in the figure. Note that although the pixel values for the on-document positions—8 to 16 are stored in fields of the table in FIG. 12A, this is for convenience of drawing, and it is assumed that the pixel values for the on-document positions 17 to 24 are also stored in FIG. 12A.

FIG. 12B shows the length of the inter-color sensor gaps 205, 207. FIG. 12B explains that the inter-color sensor gaps 205 and 207 both have a length corresponding to four lines of the document.

FIG. 12C is a table showing a correspondence relationship between a document feeding condition and an on-document position. The document feeding condition is the number of lines corresponding to a distance by which the document conveyor 7 actually conveys the document between the current read on-document position and the next read on-document position. A B sensor position indicates the on-document position being read by the sensor LB at that point in time. Similarly, a G sensor position and an R sensor position indicate the on-document positions being read by the sensors LG and LR at that time, respectively.

The sensors LB, LG, and LR are arranged four lines apart from each other along the conveying direction. Therefore, the lines read from the document by the sensors LB, LG, and LR at the same time are not the same line. Here, timings at which the sensors LB, LG, and LR read the same line L of the document is considered. After the sensor LB reads the line L, the sensor LG reads the line L when the document conveyor 7 conveys the document by four lines. Similarly, after the sensor LG reads the line L, the sensor LR reads the line L when the document conveyor 7 conveys the document by four lines.

For example, a value 209 in FIG. 12C indicates that the sensor LB reads the line #0 of the document. A value 211 indicates that the sensor LG reads the line #0 of the document after the document conveyor 7 conveys the document by four lines from that timing. Similarly, a value 213 indicates that the sensor LR reads the line #0 of the document after the document conveyor 7 conveys the document by four lines from the timing at which the sensor LG reads the line #0 of the document. It is obvious that the lines that the sensors LB, LG, and LR read at the same time are different from each other, as indicated by values 217.

FIG. 12D is a table showing a correspondence relationship between the on-document positions read by the respective sensors RGB, where the respective on-document positions are shifted by the respective inter-color sensor gaps and combined. An on-document position index represents an on-document position read by each sensor RGB at each timing. In a situation where the document is normally conveyed (a situation where the document being conveyed is not temporarily stopped), the on-document position index is incremented by one. On the other hand, at the timing when the document being conveyed is temporarily stopped, the value of the on-document position index remains the same value and is not incremented. At this time, the on-document position index is the same as that at the immediately preceding timing.

For example, in a column 215 are the line #0 (value 209) read by the sensor LB, the line number (value 211) of the line read by the sensor LG at the timing when the document conveyor 7 conveys the document by four lines from after the sensor LB reads the line #0, and the line number (value 213) of the line read by the sensor LR at the timing when the document conveyor 7 conveys the document by four lines after the sensor LG reads the line #0 are combined. In FIG. 12D, since the document conveyor 7 conveys the document at a constant conveyance speed, the line numbers in each column match each other from the beginning to the end.

FIG. 12E is a table showing pixel values output by the sensors RGB at the on-document positions in FIG. 12D and a color determined by a combination of the pixel values. A value 203 in FIG. 12A corresponds to values 219 in FIG. 12E. Each column in FIG. 12E corresponds to each column in FIG. 12D. For example, the values 219 correspond to the second column from the left in FIG. 12D. That is, 255 is stored as the values 219 as the output of the sensor LB, and this value of 255 is the read value output from the sensor LB at the on-document position #1 read by the sensor LB in the second column from the left in FIG. 12D. Referring to values of fields of “appearance” in FIG. 12E, each value is either W (white) or K (black), and no color shift occurs.

### 2.2.2 Output 1 of Three-Line CCD When Color Shift Occurs

FIGS. 13A, 13B, 13C, 13D and 13E are tables for explaining a color shift occurrence situation in a scanned image generated using the three-line CCD. Unlike FIGS. 12A to 12E, FIGS. 13A to 13E are the tables for explaining a situation where a color shift occurs. Conditions such as the arrangement of the sensors LR, LG, and LB and the conveying direction of the document are the same as those in FIGS. 12A to 12E.

A color shift is caused by an index shift. In a normal situation where the conveyance is not temporarily stopped, the pixel position indexes are the same values between the sensors RGB. However, when a situation where the conveyance is temporarily stopped occurs, a situation is caused where the pixel position indexes do not match each other between the sensors RGB. This situation is referred to as an “index shift”. In FIG. 13D, an index shift occurs in a range 243.

Referring to FIG. 13C, a value 231 in the document feeding condition is 0. This indicates that the document conveyor 7 do not convey the document after the sensors LG, LB, and LR output values 233 until the sensors LG, LB, and LR output the next values 235. Since the document is not conveyed, the sensors LG, LB, and LR read the same line again as when outputting the values 233, and as a result, the values 235 are the same as the values 231.

Regarding the values 233 and 235, the same line read by the sensor LR twice is the line #4. For this reason, in FIG. 13D, the line #4 appears twice in succession in values 237 indicating the on-document position read by the sensor LR. Similarly, the line #8 appears twice in succession in values 239 indicating the on-document position read by the sensor LG, and the line #12 appears twice in succession in values 241 indicating the on-document position read by the sensor LB. Due to this influence, although the same line number is originally stored in the same column as in FIG. 12D, a certain line number (here, line number #6) is stored in two columns as in values 245 in FIG. 13D. Such a mismatch of the line numbers occurs in the range 243. Note that the on-document positions read by the sensors LB, LG, and LR match each other before and after the range 243.

In a case where the on-document positions read by the sensors LB, LG, and LR are erroneously combined as illustrated in FIG. 13D, the outputs of the sensors LB, LG, and LR are erroneously combined, and as a result, a color shift occurs as illustrated in FIG. 13E.

For example, in FIG. 13D, there is a column 246 in which the line numbers #7, #7, and #6 are stored in combination as the on-document positions read by the sensors LB, LG, and LR, respectively. A column 247 in FIG. 13E corresponding to the column 246 stores 255, 255, and 0 as the reading results of the sensors LB, LG, and LR, respectively. Since the output of the sensor LR, i.e., the red channel, is 0, this combination represents cyan.

Similarly, in FIG. 13D, there is a column 248 in which the line numbers #12, #11, and #11 are stored in combination as the on-document positions read by the sensors LB, LG, and LR, respectively. A column 249 in FIG. 13E corresponding to the column 248 stores 0, 255, and 255 as the reading results of the sensors LB, LG, and LR, respectively. This combination represents yellow.

### 2.2.3 Output 2 of Three-Line CCD When Color Shift Occurs

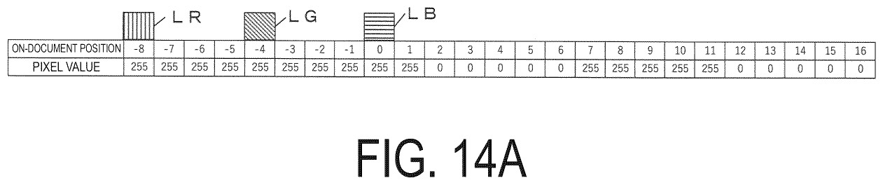

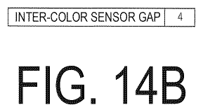

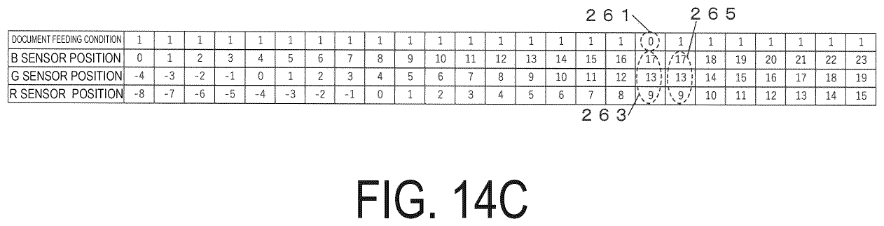

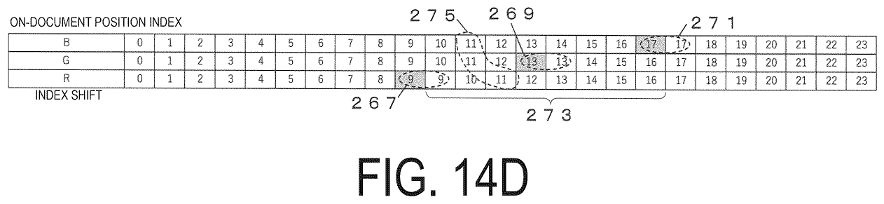

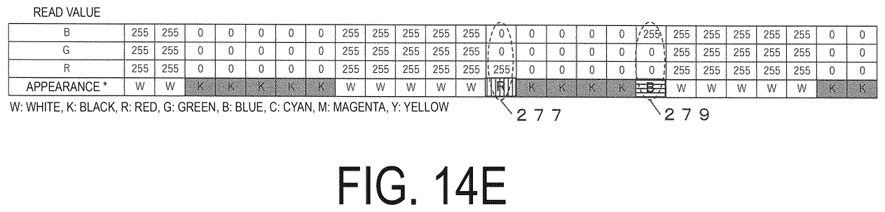

FIGS. 14A, 14B, 14C, 14D and 14E are tables for explaining a color shift occurrence situation in a scanned image generated using the three-line CCD. FIGS. 14A to 14E are the same as FIGS. 13A to 13E in that a color shift occurs, but different from FIGS. 13A to 13E in the color shift occurrence situation. Conditions such as the arrangement of the sensors LR, LG, and LB and the conveying direction of the document are the same as those in FIGS. 12A to 12E and FIGS. 13A to 13E.

FIGS. 14A to 14E are similar to FIGS. 12A to 12E, respectively. In FIG. 14C, after the sensors LB, LG, and LR read the lines #17, #13, and #9 in this order as indicated by values 263, the document is not conveyed as indicated by a value 261. Therefore, as indicated by values 265, the sensors LB, LG, and LR output the same values as the values 263.

As indicated by the values 263 and 265, each of the sensors LB, LG, and LB reads the same line on the document twice in succession. This causes a repetition of values such as at the values 267, 269, and 271 in FIG. 14D. Due to this repetition, the on-document positions read by the sensors LB, LG, and LB are erroneously combined in a range 273. For example, values 275 should be stored in the same column, but the on-document position read by the sensor LR is shifted to and stored in the next column.

As a result, the value of the on-document position #11 is used as the output of the sensor LR, as shown in a column 277 in FIG. 14E, and as a result, 0, 0, and 255 as the read values of the sensors LB, LG, and LR are combined, and are output as red by the image inputter 9. Note that this is originally the line to be output as black by the image inputter 9 by combining the read values 0, 0, and 0 output by the sensors LB, LG, and LR reading the on-document position #12.

Similarly, the value of the on-document position #17 is used as the output of the sensor LB, as shown in a column 279 in FIG. 14E, and as a result, 255, 0, and 0 as the read values of the sensors LB, LG, and LR are combined, and are output as blue by the image inputter 9. Note that this is originally the line to be output as black by the image inputter 9 by combining the read values 0, 0, and 0 output by the sensors LB, LG, and LR reading the on-document position #16.

### 2.2.3 Color Shift Situation in Three-Line CCD

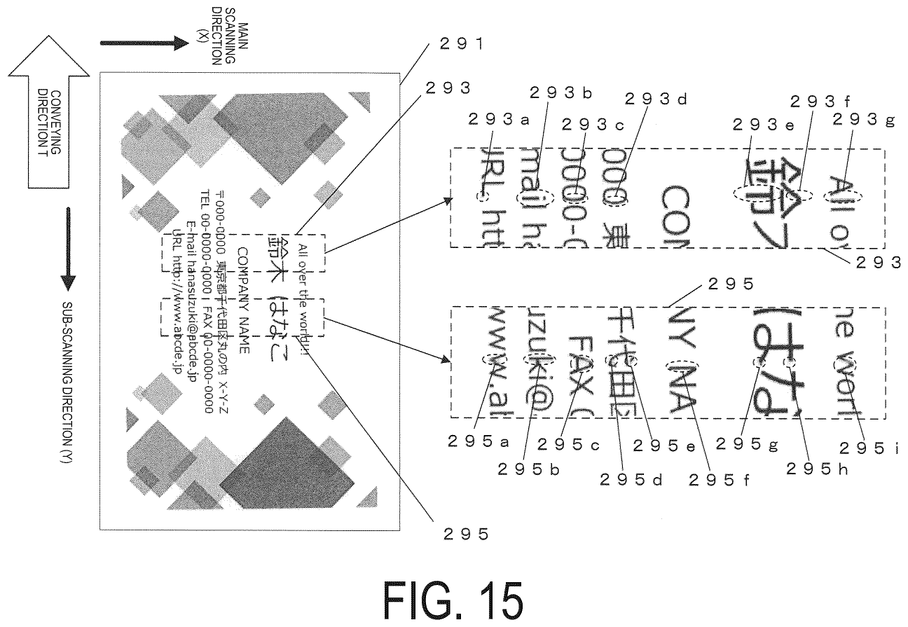

FIG. 15 is a diagram illustrating a document feeding shift of one pixel and a document feeding shift of two pixels that occur in a scanned image generated using the three-line CCD. A region 293 in a document image 291 is a region where a document feeding shift of one pixel occurs. One pixel-width color shifts are present in color shift portions 293a, 293b, 293c, 293d, 293e, 293f, and 293g. Similarly, a region 295 in the document image 291 is a region where a document feeding shift of two pixels occurs. Two pixel-wide color shifts are present in color shift portions 295a, 295b, 295c, 295d, 295e, 295f, 295g, 295h, and 295i. Note that the document image 291 indicates a state in which a name card or the like indicated by the document image 131 or the like is read in the background.

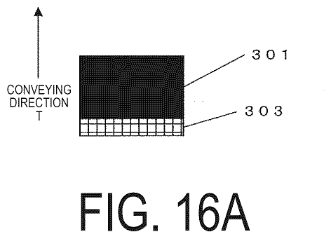

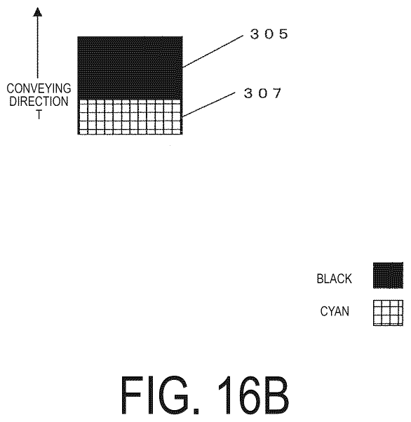

FIGS. 16A and 16B are schematic diagrams for explaining one pixel-width color shift and a two pixel-width color shift. FIG. 16A is a schematic diagram for explaining a document feeding shift of one pixel. In FIG. 16A, a black region 301 in which no color shift occurs is continuously adjacent to a cyan region 303 discolored due to a color shift. The cyan region 303 has a length corresponding to one pixel in the conveying direction T. FIG. 16B is a schematic diagram for explaining a document feeding shift of two pixels. In FIG. 16B, a black region 305 in which no color shift occurs is continuously adjacent to a cyan region 307 discolored due to a color shift. The cyan region 307 has a length corresponding to two pixels in the conveying direction T.

### 2.4 Estimation of Portion Where Same On-Document Position is Read

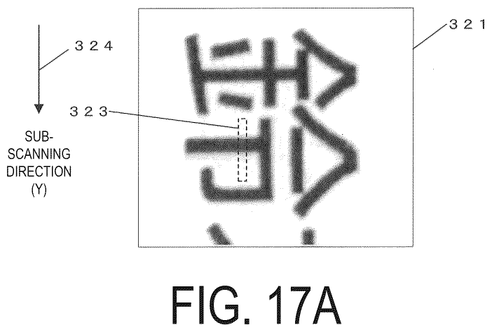

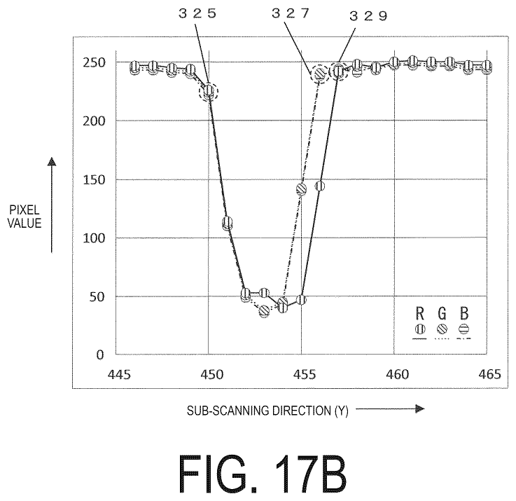

FIGS. 17A and 17B are diagrams for explaining a method of estimating a portion where the three-line CCD repeatedly reads the same position on a document, based on a color shift occurring in a scanned image generated using the three-line CCD. FIG. 17A is a diagram to specify a portion including the color shift in the scanned image. FIG. 17B is a graph showing a correspondence between the pixel values of RGB and the Y-coordinate value in the portion specified in FIG. 17A.

A document image 321 includes a region 323. An arrow 324 indicates the sub-scanning direction in FIG. 15, which is opposite to the conveying direction. The graph in FIG. 17B is a graph in which the direction of the arrow 324 (sub-scanning direction) is the positive direction of the horizontal axis and the pixel value (0 to 255) is the vertical axis. In FIG. 17B, the outputs of the sensors LR, LG, and LB in the region 323 are drawn as curves corresponding to the red channel (R), the green channel (G), and the blue channel B.

The curves of the red, green, and blue channels are substantially common in that they draw a downwardly convex curve having a minimum value in the vicinity of a value of 453 to 454 on the horizontal axis, but have rising/falling points different from each other depending on the channel. On the left side in FIG. 17B, the curves of the red, green and blue channels have a substantially common falling point 325. On the other hand, on the right side in FIG. 17B, the curves of both the green and blue channels have a rising point 327, while the curve of the red channel has another rising point 329. In this way, a portion where a shift between the rising point 327 and the rising point 329 occurs appears as a color shift in the document image.

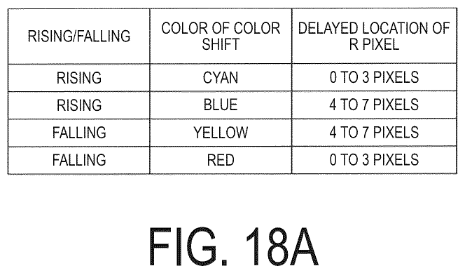

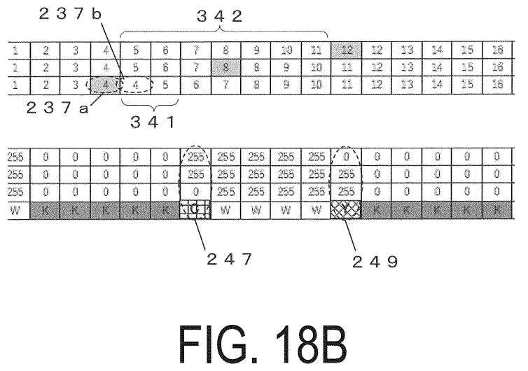

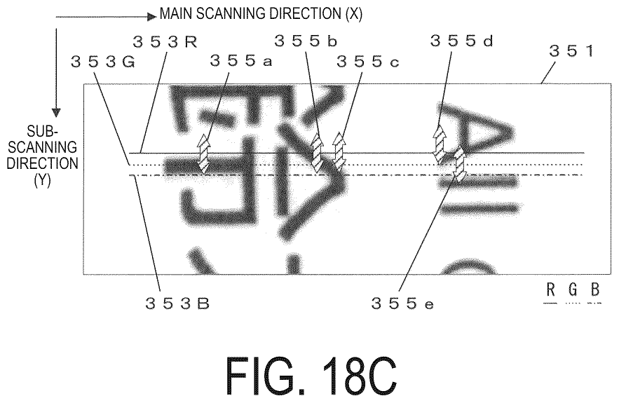

As described above, the three sensors LB, LG, and LR are arranged in this order along the conveying direction to read the document. There is the inter-color sensor gap corresponding to four lines between the sensor LG and the sensor LB, and between the sensor LR and the sensor LG. In this case, there is a relationship between the rising and the falling, the color appearing in the document image due to the color shift, and the delayed location of the R pixel as illustrated in FIGS. 18A to 18C.

FIG. 18B is a table, excerpted from FIG. 13D and FIG. 13E, for explaining, as an example, a case where a color of the color shift is cyan. A column 247 corresponds to a rising point of the blue channel and the green channel, and the appearance of the column 247 is cyan C. At this time, as can be seen from the fact that the same on-document position #4 is repeated twice at values 237a and 237b, a delay occurs in the red channel at the value 237b. A distance 341 between the value 237b and the column 247 is two pixels. This corresponds to the description in FIG. 18A, on the second row in the table, in which the rising/falling is “rising”, the color of the color shift is “cyan”, and the delayed location of the R pixel is “0 to 3 pixels”.

Also, the column 249 correspond to the falling point of the blue channel, and the appearance of the column 249 is yellow (Y). At this time, a distance 342 between the value 237b where the delay occurs in the red channel and the column 249 is 7 pixels. This corresponds to the description in FIG. 18A, on the fourth row in the table, in which the rising/falling is “falling”, the color of the color shift is “yellow”, and the delayed location of the R pixel is “4 to 7 pixels”.

In this way, the rising points/falling points of the color shifts occurring at different positions of the scanned image are specified, and the corresponding ranges of the delayed location of the R pixel are indicated by double-headed arrows 355a to 355e in FIG. 18C. The ranges indicated by the double-headed arrows 355a to 355e do not coincide with each other.

However, these delays of the R pixel are estimated to be caused by the delay of the identical document conveyance. Therefore, the delayed location of the R pixel is specified by obtaining a common range of the double-headed arrows 355a to 355e. The delayed location of the R pixel specified in this way is a line 353R in FIG. 18C.

As described above, there is the inter-color sensor gap corresponding to four lines between the sensor LG and the sensor LB, and between the sensor LR and the sensor LG. Therefore, the delayed location of the G pixel is shifted toward the rear in the conveying direction by four pixels from the delayed location of the R pixel. Similarly, the delayed location of the B pixel is shifted toward the rear in the conveying direction by four pixels from the delayed location of the G pixel. For example, as illustrated in FIG. 18C, if the delayed location of the R pixel is specified as the position of the line 353R, the delayed locations of the G pixel and the B pixel can be specified as lines 353G and 353B, respectively.

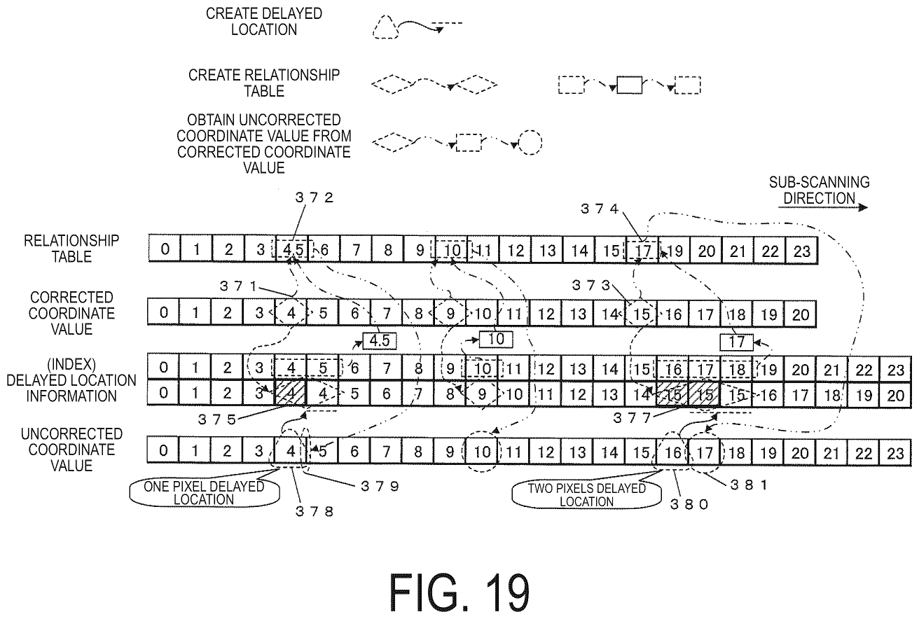

FIG. 19 is a diagram for explaining a map function for color shift correction. As described above, the color shift in the three-line CCD occurs when each sensor of RGB reads a position shifted from a position to be originally read because the conveyance of the document is temporarily stopped. When the correspondence relationship between the pixel position of the scanned image in which the color shift occurs and the original position to be read by the sensor is known, an image in which the color shift is corrected can be generated based on information of the correspondence relationship. The information indicating the correspondence relationship is a relationship table in FIG. 19.

At the portion where the conveyance of the document is temporarily stopped, the same position of the document is read, and the document is converted to be stretched in the document conveying direction. Taking this conversion as a mapping, the relationship table represents the map function of this conversion.

Terms used in FIG. 19 are described. The corrected coordinate value is a coordinate value of a pixel of an ideal document image without color shift. The uncorrected coordinate value is a coordinate value of a pixel of an image having a color shift obtained immediately after scanning the document. Delayed location information corresponds to an actual Y-coordinate on the document (position originally read by the sensor) read at the pixel position corresponding to the uncorrected coordinate value. Numerical values arranged along the upper part of the delayed location information are index values for referring to the delayed location information. The delayed location information is information corresponding to the on-document position indexes in FIGS. 12D, 13D, and 14D, and is different between the sensors RGB in a state where the color shift occurs as illustrated in the on-document position indexes in FIGS. 13D and 14D. For this reason, the delayed location information is individually created for each sensor RGB. The relationship table created from the delayed location information is also created individually for each sensor RGB. Note that instead of individually creating the delayed location information and the relationship table for each sensor, the delayed location information and the relationship table only for a sensor of one specific color (for example, the sensor LR) may be created. In this case, these delayed location information and relationship table are also used for the sensors of other colors (for example, the sensor LG and the sensor LB) by shifting, for reference, these delayed location information and relationship table by the respective inter-color sensor gaps.

Values 378 and 380 in FIG. 19 are delayed locations specified by the procedure described above with reference to FIGS. 18A to 18C. A value 378 indicates the delayed location at which a document feeding shift of one pixel occurs. The value 380 indicates the delayed location at which a document feeding shift of two pixels occurs.

In step S37, the delayed location information is created by the following procedure. An initial value of a variable n for configuring the delayed location information is set to 0. A table of the uncorrected coordinate values and a table of the delayed location information are sequentially referred to from the head, to set n in the table of the delayed location information while incrementing n by 1 until the delayed location is reached. When the delayed location is reached, a value considering the number of pixels of which the document feed deviation occurs is set in the delayed location information table without incrementing n. The above procedure is performed until the end of the table of uncorrected coordinate values.

In step S39, the relationship table is created in the following procedure. Processing is performed sequentially from the head of the corrected coordinate values. The table of the delayed location information is searched for the value of the corrected coordinate value to obtain the corresponding index value. When there are a plurality of search results, an average value of the corresponding index values is set as the value in the relationship table, and when there is one search result, the index value is set as it is as the value in the relationship table. The above procedure is performed until the end of the table of uncorrected coordinate values.

Note that a length of the table of the corrected coordinate values and a length of the relationship table are equal to or less than a length of the table of the uncorrected coordinate values. The length of the corrected coordinate values and the length of the relationship table are the same. A difference between the length of the table of the corrected coordinate values (or the length of the relationship table) and the length of the table of the uncorrected coordinate values is the sum of the numbers of delay pixels. In the case of FIG. 19, this difference is three pixels which is the sum of one pixel delay associated with the value 378 and two pixels delay associated with the value 380.

Next, in step S29, the uncorrected coordinate values are obtained from the corrected coordinate values using the relationship table by the following procedure. The coordinate values of the image whose color shift is corrected are represented by (x, y). A value in the relationship table corresponding to the corrected coordinate value y is obtained as y′. y′ is the uncorrected coordinate value. The coordinate values (x, y′) is coordinate values for referring to the scanned image in which the color shift occurs. Since y′ may not be an integer value, an image in which the color shift is corrected can be obtained by performing an appropriate interpolation calculation on the scanned image in which the color shift occurs by using values of pixels around the referred position. Note that since the relationship table is individually created for each sensor RGB, the value of y′ is different between RGB.

### 2.5 Effects

According to the second embodiment, it is possible to correct the color shift and the distortion generated in the document image due to the delay in conveyance of the document.

### 3. Third Embodiment

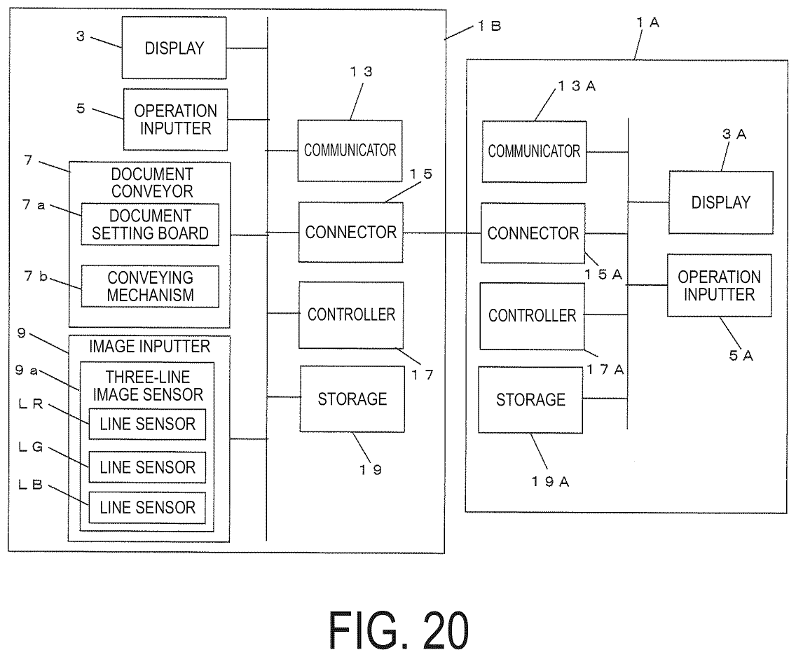

A third embodiment is described. In the first embodiment, only the MFP 1 is provided, and the MFP 1 includes the document conveyor 7 and the image inputter 9. In contrast, an image processing system 400 according to the third embodiment includes, as illustrated in FIG. 20, an image processing device 1A and an image input device 1B, and the image processing device 1A does not include the document conveyor 7 and the image inputter 9.

The image processing device 1A is, for example, a personal computer such as a laptop computer or a desktop computer, a workstation, a tablet, or the like. The image processing device 1A includes a display 3A, an operation inputter 5A, a communicator 13A, a connector 15A, a controller 17A, and a storage 19A. The display 3A, the operation inputter 5A, the communicator 13A, the connector 15A, the controller 17A, and the storage 19A are the same as the display 3, the operation inputter 5, the communicator 13, the connector 15, the controller 17, and the storage 19, respectively. The image processing device 1A is connected to the image input device 1B via the connectors 15A and 15.

The image input device 1B is, for example, a color scanner apparatus. The image input device 1B performs an operation corresponding to step S1 in FIG. 5. In the image input device 1B, the controller 17 controls the document conveyor 7 to convey a document to the image inputter 9. Next, the controller 17 controls the image inputter 9 to read the document to generate a document image. Next, the controller 17 controls the connector 15 to transmit data of the document image to the image processing device 1A.

In the image processing device 1A, when the connector 15A receives the document image data, the controller 17A performs an operation corresponding to the operations in step S3 and the subsequent steps in FIG. 5 on the received document image data. The output destination of the message in step S9 is the display 3A. An output destination of the document image in step S11 may be the display 3A, the storage 19A, another device (for example, image input device 1B) connected via the connector 15A, or another device connected via the communicator 13A and a communication line.

According to the third embodiment, the image processing device 1A can detect a color shift of the document image generated by the image input device 1B which cannot detect the color shift of the document image.

### 4. Fourth Embodiment

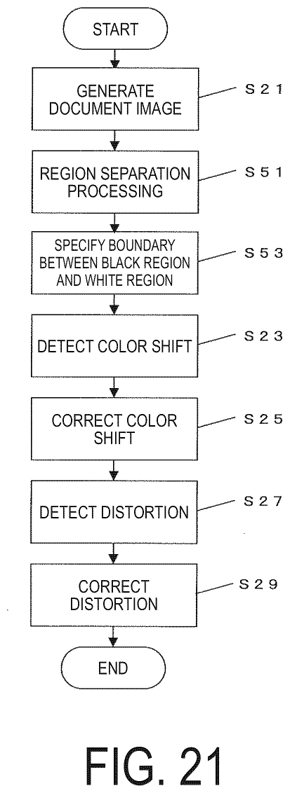

The present embodiment is a variation of the second embodiment. In the second embodiment, a monochrome image is used as a document image. In contrast, in the fourth embodiment, a color document is used as a document image. FIG. 21 is a flowchart for explaining an operation of an MFP according to the fourth embodiment of the disclosure. The operation according to the fourth embodiment is different from the operation (flowchart in FIG. 10) according to the second embodiment in that steps S51 and S53 are included.

The controller 17 controls the document conveyor 7 to convey a color document to the image inputter 9, and controls the image inputter 9 to generate a document image from the color document (step S21). Next, the controller 17 performs region separation processing to detect a black region (a region formed using only black, for example, a black character, a black solid, or the like), a document background, and other regions from the document image (step S51). Next, the controller 17 specifies the black region from among the regions separated in step S51 (step S53). Next, the controller 17 detects a color shift in the specified black region (step S23). The detection method is the same as that performed on the document image in the second embodiment. Next, the controller 17 generates a document image in which the detected color shift is corrected to a color in the case where no color shift occurs (step S25). At this time, the controller 17 corrects the color shift of the document image on the assumption that the color shift occurs not only in the black region but also across the entire width of the document image for the Y-coordinate where the color shift is detected in the black region. The correction method is the same as that performed on the document image in the second embodiment. Next, the controller 17 detects a distortion of the document image based on the document image after the color shift is corrected (step S27). Next, the controller 17 generates a document image in which the detected distortion is corrected (step S29). According to the present embodiment, it is possible to correct the color shift in the document image generated by reading the color document.

### 5. Fifth Embodiment

The fifth embodiment is a variation of the second embodiment. In the fourth embodiment, in order to address the color document, the color shift in the black region in the document image is detected by performing the region separation processing and specifying the boundary between the black region and the white region on the document image, and the color shift in the entire document image is detected and corrected based on the detected color shift. The fifth embodiment addresses the color document by another method.

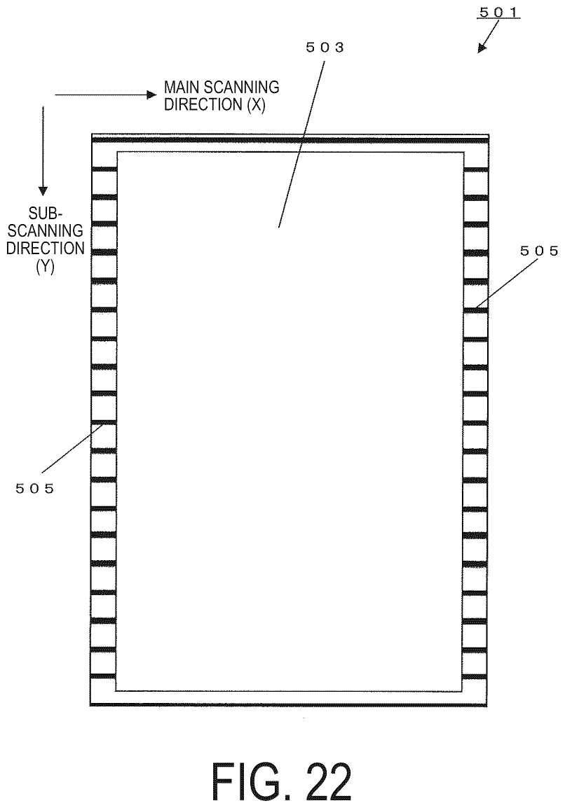

FIG. 22 is a diagram for explaining a medium 501 used when creating a color document in a variation of the fifth embodiment of the disclosure. The medium 501 is a medium such as copy paper for depicting characters, images, and the like of a document. The medium 501 includes a document field 503 and black lines 505. The document field 503 is a region for depicting characters, images, and the like as a document. The black lines 505 are black lines formed outside the document field 503 regardless of the content of the document. The black lines 505 are formed at equal intervals in a direction orthogonal to the sub-scanning direction. As many black lines 505 as possible are preferably formed as long as the three-line image sensor 9a can identify the black lines 505 one by one.

In the MFP 1 according to the second embodiment, when the media 501 having the document field 503 on which a color document is depicted is read, the MFP 1 can detect a color shift of the black line 505. Based on this, the MFP 1 can correct the color shift of the color document image.

### 6. Variations

The disclosure is not limited to the embodiments and variations described above and various modifications thereof can be made. That is, embodiments obtained by combining technical mechanisms appropriately changed without departing from the gist of the disclosure are also included in the technical scope of the disclosure.

In the second embodiment, with reference to FIGS. 18A to 18C, the delayed location of the R pixel is estimated and then the delayed locations of the G pixel and the B pixel are estimated based on the inter-color sensor gaps. However, the pixel first estimated is not limited to the R pixel. A table similar to that in FIG. 18A may be prepared for the delay of the G pixel, the delayed location of the G pixel may be estimated, and then the delayed locations of the B pixel and the R pixel may be estimated based on the inter-color sensor gaps. Similarly, a table similar to that in FIG. 18A may be prepared for the delay of the B pixel, the delayed location of the B pixel may be estimated, and then the delayed locations of the G pixel and the R pixel may be estimated based on the inter-color sensor gaps. Further, instead of estimating the delayed locations of the pixels of the other two colors based on the estimation result of the delayed location of the pixel of one specific color and the inter-color sensor gaps, a table similar to FIG. 18A may be prepared for each color of RGB, and the delayed locations of the RGB pixels may be estimated based on the respective corresponding tables.

In the third embodiment, the image processing device 1A obtains the data of the document image via the connector 15A, but the method of obtaining the document image data is not limited thereto. For example, the document image data may be received from the image input device 1B via the communicator 13A, the communication line, and the communicator 13. Alternatively, the image input device 1B may store the document image data in an external storage device not illustrated in the figure (e.g., universal serial bus (USB)) connected to the connector 15, and the external storage device may be connected to the connector 15A of the image processing device 1A to obtain the document image data.

The programs running on each device in the embodiments are programs for controlling a CPU or the like (programs for causing a computer to function) to implement the aforementioned functions in the embodiments. The information handled by these devices is temporarily accumulated in a transitory storage device (for example, a RAM) at the time of processing, is then stored in a storage device such as various read only memories (ROMs) or HDDs, and is read, corrected, and written by the CPU as needed.

The recording medium storing the programs may be any of a semiconductor medium (for example, a ROM or a nonvolatile memory card), an optical recording medium or a magneto-optical recording medium (for example, a digital versatile disc (DVD), a magneto optical disc (MO), a mini disc (MD), a compact disc (CD), or a Blu-ray (trade name) disc (BD)), a magnetic recording medium (for example, a magnetic tape or a flexible disk), and the like. Not only the aforementioned functions of the embodiments are implemented by executing the loaded programs, but also the functions of the disclosure may be implemented by performing processing in cooperation with an operating system, another application program, or the like based on commands of the programs.

In a case where the programs are distributed to the market, the programs can be stored and distributed in a portable recording medium, or can be transferred to a server computer connected via a network such as the Internet. In this case, it is a matter of course that the storage device of the server computer is also included in the disclosure.

1. An image processing device comprising:
a controller; and
an image acquiring device, wherein
the controller
acquires, by using the image acquiring device, a document image including a first image, a second image, and a third image generated sequentially by using a first sensor, a second sensor, and a third sensor, respectively, the first sensor, second sensor, and third sensor being image sensors that are arranged in accordance with a predetermined order relationship along a conveying direction of a document and read color components of three colors different from each other,
compares the first image, second image, and third image with each other, and
determines whether the document image contains a color shift from the document, based on a result of the comparison.

2. The image processing device according to claim 1, wherein
the controller
estimates a position at which a color shift from the document occurs in the document image, based on a change in a pixel value of the document image in the conveying direction, and
estimates a pixel in which a delay occurs in the document image, based on the estimated position.

3. The image processing device according to claim 2, wherein
the controller
compares risings and fallings of changes in pixel values of the first image, second image, and third image in the conveying direction with each other, and
estimates the position at which a color shift from the document occurs, based on a result of the comparison.

4. The image processing device according to claim 3, wherein
the controller
determines a color appearing in the document image at risings or fallings of the changes in the pixel values of the first image, second image, and third image, and
estimates a magnitude of a delay of a pixel in any one of the first image, second image, and third image, based on the determined color.

5. The image processing device according to claim 1, comprising, as the image acquiring device, an image scanner, wherein
the image scanner includes a first sensor, a second sensor, and a third sensor being image sensors that are arranged in accordance with a predetermined order relationship along a conveying direction of a document and read color components of three colors different from each other.

6. The image processing device according to claim 1, comprising, as the image acquiring device, a connector that connects the image processing device to another device or a communicator that connects the image processing device to another device via a communication line, wherein
the controller acquires the document image from the other device via the connector or the communicator.

7. A control method for an image processing device, the method being executed by one or more processors and comprising:
acquiring, from an image acquiring device, a document image including a first image, a second image, and a third image generated sequentially by using a first sensor, a second sensor, and a third sensor, respectively, the first sensor, second sensor, and third sensor being image sensors that are arranged in accordance with a predetermined order relationship along a conveying direction of a document and read color components of three colors different from each other;
comparing the first image, second image, and third image with each other; and
determining whether the document image contains a color shift from the document, based on a result of the comparison.
